(19) United States
(12) Patent Application Publication
(10) Pub. No.: US 2025/0316268 A1
(43) Pub. Date: Oct. 9, 2025

(54) Apparatus and Method and for Correcting Result of Speech Recognition by Using Camera

(71) Applicants: Hyundai Motor Company, Seoul (KR); Kia Corporation, Seoul (KR)

(72) Inventor: Sung Soo Park, Seoul (KR)

(21) Appl. No.: 18/969,979

(22) Filed: Dec. 5, 2024

(30) Foreign Application Priority Data
Apr. 5, 2024 (KR) 10-2024-0046339

(51) Int. Cl. G10L 15/22; G10L 15/20

(52) U.S. Cl. CPC G10L 15/22; G10L 15/20; G10L 2015/223

(57) ABSTRACT

An apparatus and method for correcting results of speech recognition by using a camera is disclosed. A speech recognition apparatus may include: memory storing instructions; and at least one processor. The at least one processor may be configured to: receive, via a microphone, an utterance spoken by a user; identify, based on one or more images received from a camera of a vehicle, context information indicating: an action of the user while speaking the utterance, and an object associated with the action; identify, based on performing speech recognition on the utterance, an intent of the utterance; identify, based on the intent and based on a sentence type associated with the utterance, an ambiguity associated with the utterance; adjust, based on the ambiguity and the context information, a result of the speech recognition; and control, based on the adjusted result of the speech recognition, an operation of the vehicle.

### CROSS-REFERENCE TO RELATED APPLICATION

This application claims priority to Korean Patent Application No. 10-2024-0046339, filed on Apr. 5, 2024, in the Korea Intellectual Property Office, the entire contents of which are incorporated herein by reference

### TECHNICAL FIELD

The present disclosure relates to an apparatus and method for speech recognition.

### BACKGROUND

The statement herein merely provides background information related to the present disclosure and may not necessarily constitute the prior art.

A speech recognition system refers to a system consisting of hardware and/or software that automatically recognizes a linguistic meaning from a speech signal. The speech recognition system may be further classified as a word recognition system, a continuous speech recognition system, or a speaker recognition system. The word recognition system and the continuous speech recognition system may be viewed as a speech recognition system in a narrow sense that can interpret a voice command or a speech input to a computer. The speaker recognition system is a system that identifies or authenticates a speaker, which is often used in access control or criminal investigation.

Application for speech recognition systems is expanding to a wider range of fields. Notably, it is growing in importance in line with the technical development of artificial intelligence (AI).

A speech recognition system in a vehicle may help control the vehicle and its infotainment system based on speech recognition and natural language processing technologies, and provide guidance on vehicle-related terms and usage. However, if the driver speaks hurriedly or use ambiguous words, natural language processing may have a more difficult time discerning the speech accurately.

### SUMMARY

In view of the above, the present disclosure is directed to correcting ambiguous words that might come up in a driving situation to create a sentence that can be understood in natural language, by using information from a vehicle interior camera.

The aspects of the present disclosure are not limited to the foregoing, and other aspects not mentioned herein will be able to be clearly understood by those skilled in the art from the following description.

According to one or more example embodiments of the present disclosure, a speech recognition apparatus may include: memory storing instructions; and at least one processor. The at least one processor, by executing the instructions, may be configured to: receive, via a microphone in a vehicle, an utterance spoken by a user of the vehicle; identify, based on one or more images received from a camera of the vehicle, context information indicating: an action of the user while speaking the utterance, and an object associated with the action; identify, based on performing speech recognition on the utterance, an intent of the utterance; identify, based on the intent and based on a sentence type associated with the utterance, an ambiguity associated with the utterance; adjust, based on the ambiguity and the context information, a result of the speech recognition; and control, based on the adjusted result of the speech recognition, an operation of the vehicle.

The at least one processor may be configured to identify the context information by: identifying the context information further based on a core action priority database and a core action-free database.

The at least one processor may be configured to identify the context information by: identifying, based on the user performing a plurality of actions, the action according to the core action priority database. The core action priority database may indicate a higher priority for a more specific action of the plurality of actions.

The at least one processor may be configured to identify the ambiguity by: identify the ambiguity further based on the intent being out-of-domain and the utterance including a demonstrative pronoun.

The at least one processor may be configured to identify the ambiguity by: identify the ambiguity further based on the intent being out-of-domain and the utterance only containing an adverb or a predicate.

The at least one processor may be configured to adjust the result of the speech recognition by: determining whether the user is performing a plurality of actions; receiving, based on the user performing the plurality of actions, additional context information indicating a second object associated with a second action; and adjusting the result of the speech recognition based on the additional context information.

The at least one processor is configured to: output, based on the intent of the utterance being out-of-domain with respect to the result of the speech recognition and the adjusted result of the speech recognition, a notification that the intent of the utterance corresponds to an unsupported feature.

According to one or more example embodiments of the present disclosure, a speech recognition method performed by an apparatus of a vehicle may include: receiving, via a microphone in the vehicle, an utterance spoken by a user of the vehicle; identifying, based on one or more images received from a camera of the vehicle, context information indicating: an action of the user while speaking the utterance, and an object associated with the action; identifying, based on performing speech recognition on the utterance, an intent of the utterance; identifying, based on the intent and based on a sentence type associated with the utterance, an ambiguity associated with the utterance; adjusting, based on the ambiguity and the context information, a result of the speech recognition; and controlling, based on the adjusted result of the speech recognition, an operation of the vehicle.

Identifying the context information may include: identifying the context information further based on a core action priority database and a core action-free database.

Identifying the context information may include: identifying, based on the user performing a plurality of actions, the action according to the core action priority database. The core action priority database may indicate a higher priority for a more specific action of the plurality of actions.

Identifying the ambiguity may include: identify the ambiguity further based on the intent being out-of-domain and the utterance including a demonstrative pronoun.

Identifying the ambiguity may include: identify the ambiguity further based on the intent being out-of-domain and the utterance only containing an adverb or a predicate.

Adjusting the result of the speech recognition may include: determining whether the user is performing a plurality of actions; receiving, based on the user performing the plurality of actions, additional context information indicating a second object associated with a second action; and adjusting the result of the speech recognition based on the additional context information.

The speech recognition method may further include: outputting, based on the intent of the utterance being out-of-domain with respect to the result of the speech recognition and the adjusted result of the speech recognition, a notification that the intent of the utterance corresponds to an unsupported feature.

The effects of the present disclosure are not limited to the foregoing, and other effects not mentioned herein will be able to be clearly understood by those skilled in the art from the following description.

### BRIEF DESCRIPTION OF THE DRAWINGS

FIG. 1 is a schematic block diagram of a speech recognition system.

FIG. 2 is a view illustrating a process in which the vehicle situation information determination unit classifies the speaker's actions based on a learned algorithm and selects the most important action.

FIG. 3 is a view illustrating a process in which the natural language processing engine classifies the speaker's intent.

FIG. 4 is a flowchart illustrating a process in which the ambiguity determination unit determines a sentence to be ambiguous.

FIG. 5 is a view illustrating a process of correcting a speech recognition result.

FIG. 6 is a view illustrating a process of correcting a speech recognition result and sending feedback.

FIG. 7 is a flowchart illustrating a method of correcting a speech recognition result.

FIG. 8 is a block diagram schematically showing an exemplary computing device that can be used to implement the method or apparatus according to the present disclosure

### DETAILED DESCRIPTION

Hereinafter, one or more example embodiments of the present disclosure will be described in detail with reference to the accompanying drawings. In the following description, like reference numerals preferably designate like elements, although the elements are shown in different drawings. Further, in the following description of the example embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Throughout the present disclosure, references to components, units, or modules generally refer to items that logically can be grouped together to perform a function or group of related functions. Like reference numerals are generally intended to refer to the same or similar components. Components, units, and modules may be implemented in software, hardware or a combination of software and hardware. The components, units, modules, and/or functions described above may be implemented and/or performed by one or more processors. For examples, the components, units, and/or modules may include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The components, units, and/or modules may also include software control module(s) implemented with a processor or logic circuitry for example. The components, units, and/or modules may include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. One or more storage type media may include any or all of the tangible memory of computers, processors, or the like, or associated modules thereof, such as various semiconductor memories, tape drives, disk drives and the like, which may provide non-transitory storage at any time for software programming.

The following detailed description, together with the accompanying drawings, is intended to describe one or more example embodiments of the present disclosure, and is not intended to represent the only embodiments in which the present disclosure may be practiced.

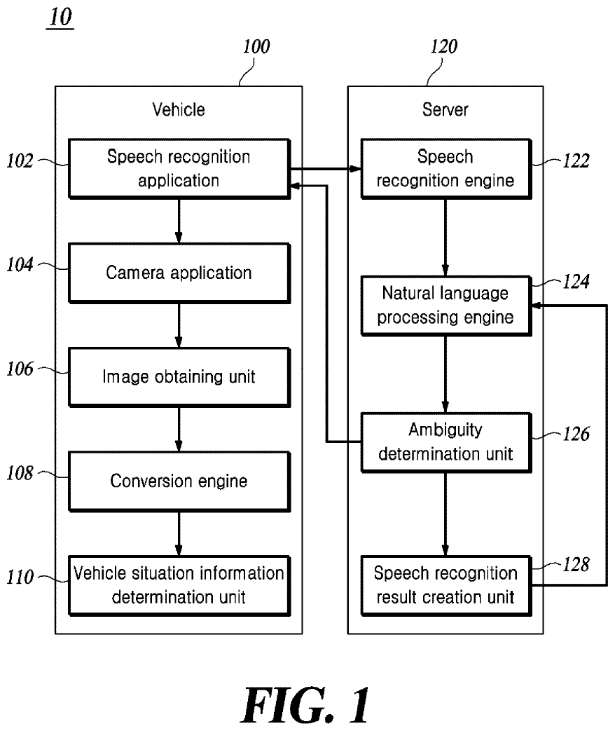

FIG. 1 is a conceptual diagram schematically showing a speech recognition system by using a vehicle interior camera. The components illustrated in FIG. 1 are functionally distinguished components, and at least one of the components may be implemented in such a way as to be integrated together in an actual physical environment.

A speech recognition system 10 may be a system that corrects a speech recognition result, including a vehicle 100 and a server 120. The speech recognition system 10 may correct a speech recognition result that is hard to be understood in natural language, so as to make it understandable and create a response according to the speaker's intent.

The vehicle 100 includes a speech recognition application 102, a camera application 104, an image obtaining unit 106, a conversion engine 108, and a vehicle situation information determination unit 110.

The speech recognition application 102 and the camera application 104 are executed simultaneously or sequentially. The speech recognition application 102 may need to obtain an image from an interior camera in order to find out what situation the vehicle is in.

The camera application 104 obtains an image of the speaker's action.

The image obtaining unit 106 is run as the speech recognition application 102 and the camera application 104 are executed simultaneously or sequentially, and sends an image of the vehicle's interior to the conversion engine 108.

The conversion engine 108 converts the image into text by using vision-language models (VLM). The vision-language models have the capability of processing both images and natural language text.

The vehicle situation information determination unit 110 extracts the vehicle's situation information based on text received from the conversion engine 108.

The sever 120 includes all or some of a speech recognition engine 122, a natural language processing engine 124, an ambiguity determination unit 126, and a speech recognition result creation unit 128.

The speech recognition engine 122 obtains the speaker's utterance received by a microphone in the vehicle and converts the utterance into text by using a speech-to-text (STT) engine. The STT engine may apply a speech recognition algorithm or a deep learning algorithm to a speech signal representing the user's utterance to convert the speech signal into text. As used herein, the speaker's utterance is a speech signal, and the speech recognition engine 122 receives a speech signal that corresponds to the speaker's utterance.

The natural language processing engine 124 may understand (e.g., interpret) and identify an utterance spoken by the speaker by classifying the intent of the speaker's utterance and a slot for the intent. Here, the intent of the utterance may be classified as one of the following: making a phone call, searching for a destination, turning on the radio, requesting for route description, and playing music, for example. The intent of the utterance may be classified as various domains such as changing the destination, adding a waypoint (e.g., a stopover), changing a waypoint (e.g., a stopover), making a call, and out-of-domain (OOD).

A slot refers to an entity that is required to provide information according to an intent of an utterance. The slot may be predefined for an intent of each utterance. For example, a slot for the intent of planning a journey may be destination or stopover. A keyword corresponding to the slot may be home or office.

The natural language processing engine 124 may extract information such as domain, entity name, speech act, etc. from an input sentence by using a natural language understanding (NLU) engine, for example, and extract an intent and a slot based on the extracted information.

The domain is information for identifying the subject of the speaker's utterance. For example, the domain may be determined based on the input sentence to represent various subjects such as vehicle control, provision of information, texting, and navigation.

The entity name refers to a proper noun such as a person's name, place name, organization name, time, date, currency, etc. The entity name recognition is the task of identifying an entity name in the sentence and determining the type of the entity name identified. By recognizing individual names, important keywords can be extracted from a sentence to understand the meaning of the sentence.

Speech act analysis is the task of analyzing the intent of an utterance. It is used to grasp the intent of a spoken utterance, such as whether the user asks a question, makes a request, makes a response, or expresses an emotion.

Information such as domain, entity name, speech act, etc. may be used for at least one of the following operations: classifying the intent of the speaker's utterance, determining slots, and making a response to the utterance spoken by the speaker. Specifically, the NLU engine may segment an input sentence into morphemes, project the morphemes in a vector space, classify the intent of the input sentence by grouping projected vectors, and extract different components corresponding to slots for the intent in the input sentence as entities.

For an input sentence “Make a call to John”, for instance, the NLU engine tokenizes the input sentence into “make”, “a”, “call”, “to”, and “John”. The NLU engine determines from the tokens that the intent of the input sentence is to “make a call”. A slot for the intent of the utterance is “a person to be called”, in which case the NLU engine may extract “Tom” as a keyword.

As another example, for an input sentence “Turn on the air conditioner”, the intent of the utterance is to “power on the air conditioner”, and a slot corresponding to the intent of the utterance is “temperature and wind power”.

The ambiguity determination unit 126 determines ambiguity based on the classified intent of the speaker's utterance and the types of sentences in the spoken utterance. Ambiguity may refer to a speech recognition result having a confidence level below a threshold value such that the intent of the utterance could not be classified as one of the known speech intents. The types of sentences include a sentence containing a demonstrative pronoun, a sentence containing only a predicate, a sentence containing only an adverb, and so on. Specifically, if the speaker's intent is classified as out-of-domain (OOD) by the natural language processing engine 124, the ambiguity determination unit 126 determines if the sentence is out-of-domain (OOD) or ambiguous.

For example, if the intent of the utterance spoken by the speaker is out-of-domain (OOD) and the utterance contains a demonstrative pronoun such as “this”, “that, “here”, etc., the spoken utterance is determined to be ambiguous. As another example, if the intent of an utterance spoken by the speaker is out-of-domain (OOD) and the utterance contains only a predicate such as “turn on” or “turn up”, the spoken utterance is determined to be ambiguous. As yet another example, if the intent of the utterance spoken by the speaker is out-of-domain (OOD) and the utterance contains only an adverb such as “a bit” or “to maximum”, the spoken utterance is determined to be ambiguous.

The speech recognition result creation unit 128 corrects the spoken utterance by combining results from the ambiguity determination unit 126 based on vehicle situation information. As used herein, the vehicle situation information (also referred to as context information) refers to the names of a core action and an object that are extracted from the vehicle situation information determination unit 110. The vehicle situation information may provide additional context that can be used to improve the accuracy of speech recognition and possibly alleviate or eliminate ambiguities associated with the speech or intent of a speaker.

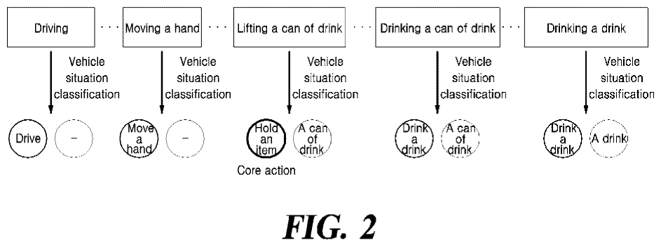

FIG. 2 illustrates a process in which the vehicle situation information determination unit 110 classifies the speaker's actions based on a learned algorithm and selects the most important action. For example, if the speaker's action involves a situation in which he or she is lifting a can of drink, the vehicle situation information determination unit 110 selects “hold an item” and “a can of drink” as the names of a core action and an object.

Referring to Table 1, the vehicle situation information determination unit 110 performs the function of selecting an object. The speaker's actions related to the object and more specific actions are stored in a core action priority database (DB). If the speaker is performing multiple actions, it is determined that, the more specific the action, the higher the priority of the action in the core action priority DB. Among these core actions, insignificant actions related to the object are stored in a core action-free DB and taken into consideration when selecting a core action.

For instance, if the speaker has done “an action of lifting a can of drink” in the vehicle, the vehicle's situation is classified by an action name “hold an item” and an object name “a can of drink”. The action name and the object name are looked up in the core action priority DB. If the action and object in question are present in the core action priority DB but not in the core action-free DB, then that action and that object are selected as a core action and an object name.

Thus, the vehicle situation information may be obtained from the speaker's action and the vehicle, based on the core action priority DB and the core action-free DB.

TABLE 1

| Core action priority DB | | | Core action-free priority DB | | |
|---|---|---|---|---|---|
| Priority | Category | Core Action | Priority | Core Action | Object |
| 1 | Contact with | Hold an item | 1 | Hold an item | Steering |
| | an object | | | | wheel |
| 2 | | Touch an | 2 | Hold an item | Gearbox |
| | | item | | | |
| 3 | Point at an | Point a | 3 | Point a | Passenger |
| | object | finger | | finger | |
| 4 | | Hold out a | 4 | Hold out a | Passenger |
| | | hand | | hand | |
| 5 | Look at an | Hold the | 5 | Hold the | Passenger |
| | object | head still | | head still | |
| 6 | | Fixed gaze | 6 | Fixed gaze | Passenger |
| + | . . . | | + | . . . | |

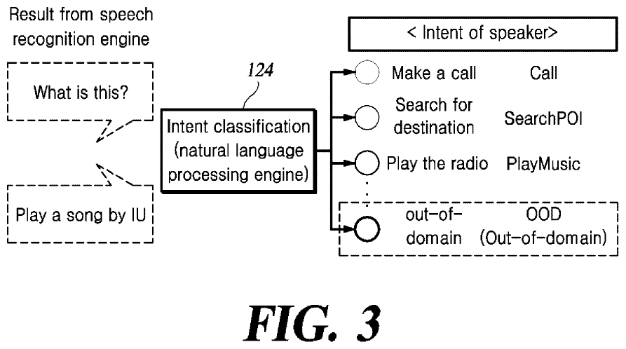

FIG. 3 is a view illustrating a process in which the natural language processing engine 124 classifies the speaker's intent.

For example, the natural language processing engine 124 classifies the speaker's intent for a text result “What is this” sent from the speech recognition engine 122.

If the intent of the utterance does not correspond to a preset feature, the intent of the speaker's utterance is classified as out-of-domain (OOD). For example, if the speaker speaks an utterance “Turn on”, it is classified as out-of-domain (OOD) because it is difficult to figure out the exact meaning—whether the intent of the utterance is “Turn on the air conditioner” or “Turn on the infotainment system's content”. As another example, if the speaker speaks an utterance “To maximum”, it is classified as out-of-domain (OOD) because it is difficult to figure out the exact meaning—whether the intent of the utterance is “Set the air conditioner to maximum” or “Set the infotainment system to maximum”.

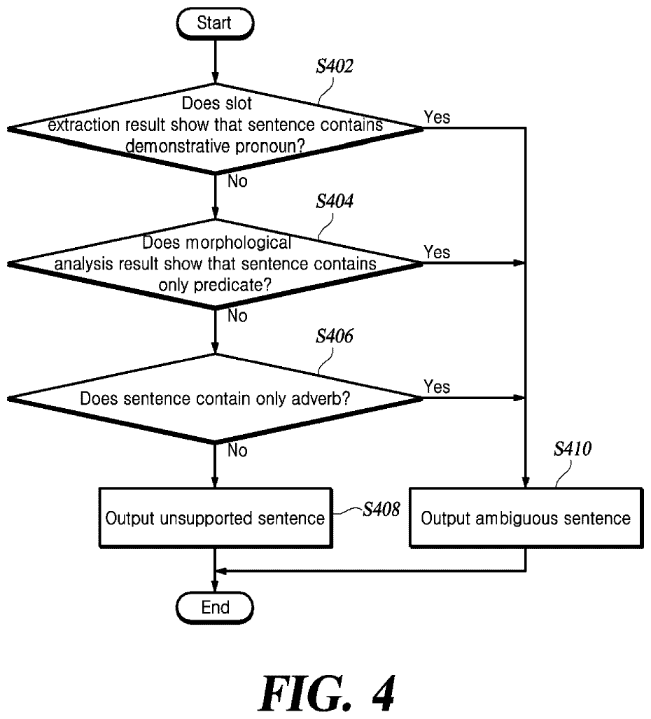

FIG. 4 is a flowchart illustrating a process in which the ambiguity determination unit 126 determines a sentence to be ambiguous.

If a slot extraction result for a sentence shows that the sentence contains a demonstrative pronoun, the sentence may be determined to be ambiguous (S402).

Here, the meaning of the expression “determined to be ambiguous” is that the intent of the spoken utterance is classified as out-of-domain (OOD), and that, if a preset sentence type is contained in the spoken utterance, the server 120 determines the spoken utterance to be ambiguous. The meaning of the expression “classified as out-of-domain (OOD)” is that the intent of the utterance does not correspond to any of preset features. In other words, the result of speech recognition may have a confidence level that is below a threshold value.

If a morphological analysis result shows that the sentence contains only a predicate and no demonstrative pronoun, the sentence is determined to be ambiguous (S404).

If the sentence contains only an adverb, the sentence is determined to be ambiguous (S406).

If the sentence does not have any of preset sentence types, the sentence is outputted as an unsupported sentence (S408).

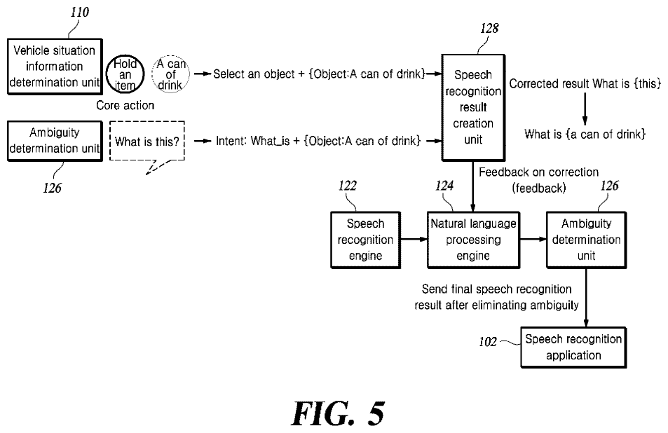

FIG. 5 is a view illustrating a process of correcting a speech recognition result.

Referring to FIG. 5, a speech recognition result from the speech recognition result creation unit 128 is corrected by combining situation information extracted from the vehicle situation information determination unit 110 and results from the ambiguity determination unit 126.

For example, if situation information extracted from the vehicle situation information determination unit 110 represents “hold a can of drink”, a core action corresponds to “hold an item” and an object name corresponds to “a can of drink”. If the speaker speaks an utterance “What is this”, for example, which contains a demonstrative pronoun, the ambiguity determination unit 126 determines the utterance to be ambiguous since it contains a demonstrative pronoun “this”. As used herein, the intent of the speaker's utterance is to “find out what the object is”, and a slot corresponding to the intent of the utterance is “demonstrative pronoun”. By assigning the object name to the corresponding slot, the speech recognition result may be corrected to change from “What is this” to “What is a can of drink”.

As another example, if situation information extracted from the vehicle situation information determination unit 110 represents “point a finger at the air conditioner”, a core action corresponds to “point a finger” and an object name corresponds to “the air conditioner”. If a morphological analysis result shows that an utterance spoken by the speaker contains only a predicate, for example, “Turn on”, the ambiguity determination unit 126 determines the sentence to be ambiguous since the sentence “Turn on” contains only a predicate. As used herein, the intent of the speaker's utterance is to “power on the air conditioner”, and a slot corresponding to the intent of the utterance is “temperature and wind power”. By assigning the object name to the corresponding slot, the speech recognition result may be corrected to change from “Turn on” to “Turn on the air conditioner”.

As yet another example, if situation information extracted from the vehicle situation information determination unit 110 represents “point a finger at the infotainment system”, a core action corresponds to “point a finger” and an object name corresponds to “the infotainment system”. For such an item as an infotainment system in which the information on the screen keeps changing, the screen information is transmitted to the server 120. If a morphological analysis result shows that an utterance spoken by the speaker contains only a predicate, for example, “Turn on”, the ambiguity determination unit 126 determines the sentence to be ambiguous since the sentence “Turn on” contains only a predicate. As used herein, the intent of the speaker's utterance is to “power on the infotainment system”, and a slot corresponding to the intent of the utterance is “channel and volume”. By assigning the object name to the corresponding slot, the speech recognition result may be corrected to change from “Turn on” to “Turn on the infotainment system's Content A”.

As a further example, if situation information extracted from the vehicle situation information determination unit 110 represents “look at the air conditioner”, a core action corresponds to “fixed gaze” and an object name corresponds to “the air conditioner”. If a morphological analysis result shows that an utterance spoken by the speaker contains only an adverb, for example, “To maximum”, the ambiguity determination unit 126 determines the sentence to be ambiguous since the sentence “To maximum” contains only an adverb. As used herein, the intent of the speaker's utterance is to “set the air conditioner to maximum output”, and a slot corresponding to the intent of the utterance is “temperature and wind power”. By assigning the object name to the corresponding slot, the speech recognition result may be corrected to change from “To maximum” to “Set the air conditioner to maximum”.

As a further example, if situation information extracted from the vehicle situation information determination unit 110 represents “look at the infotainment system”, a core action corresponds to “fixed gaze” and an object name corresponds to “the infotainment system”. If a morphological analysis result shows that an utterance spoken by the speaker contains only an adverb “To maximum”, the ambiguity determination unit 126 determines the sentence to be ambiguous. As used herein, the intent of the speaker's utterance is to “set the infotainment system to maximum output”, and a slot corresponding to the intent of the utterance is “volume”. By assigning the object name to the corresponding slot, the speech recognition result may be corrected to change from “To maximum” to “Set the infotainment system's Content A to maximum.”

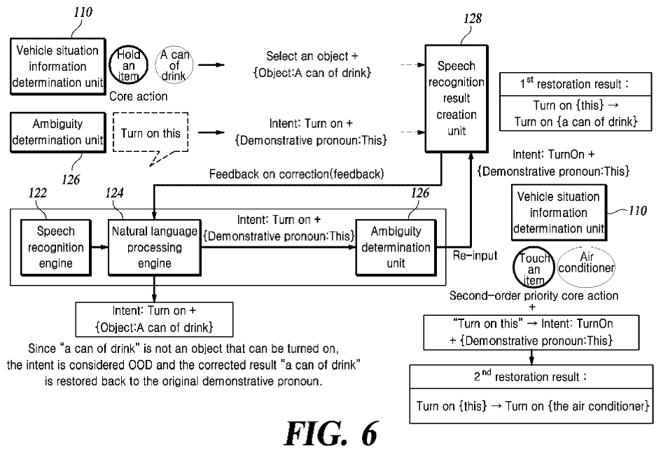

FIG. 6 is a view illustrating a process of correcting a speech recognition result and sending feedback.

A corrected result generated by the speech recognition result creation unit 128 is fed back to the natural language processing engine 124.

Once the intent of the speaker is properly classified by the natural language processing engine 124, the ambiguity determination unit 126 derives a proper result and sends the final result to the speech recognition application 102 of the vehicle 100.

However, if the intent of the utterance is considered OOD by the natural language processing engine 124 during the feedback process because the speaker's intent and the corrected speech recognition result do not match, the corrected result is restored back to the original result, and the original result is sent to the ambiguity determination unit 126.

The ambiguity determination unit 126 re-determines the ambiguity of the original result. If the speech recognition result is re-determined to be ambiguous, the vehicle situation information determination unit 110 identifies if the speaker is performing multiple actions.

If the speaker is performing multiple actions, the server 120 receives second situation information about a second object related to a second action and corrects the spoken utterance based on the second situation information about the second object in the spoken utterance to generate a corrected speech recognition result.

Specifically, if an initially corrected speech recognition result is “Turn on a can of drink”, this result is sent to the natural language processing engine 124. Since the corrected result does not match the speaker's intent, the original result “Turn on this” is sent to the ambiguity determination unit 126.

If the ambiguity determination unit 126 re-determines the original result to be ambiguous, the vehicle situation information determination unit 110 determines if the speaker is performing multiple actions. If the next priority-order core action is “touch an item” and an object name is “the air conditioner”, the intent of the speaker's utterance is to “power on the air conditioner”, and a slot corresponding to the intent of the utterance is “demonstrative pronoun”. By assigning the object name to the corresponding slot, the speech recognition result may be re-corrected to change from “Turn on” to “Turn on the air conditioner”.

The feedback process is performed until the corrected speech recognition result and the user's intent match.

However, if the intent of the utterance is out-of-domain (OOD) with respect to all speech recognition results for the multiple actions, the ambiguity determination unit 126 informs the speech recognition application 102 of the vehicle 100 that the intent of the utterance corresponds to an unsupported feature. For example, the vehicle 100 may output (e.g., to a user) a notification that the intent of the utterance corresponds to an unsupported feature (e.g., does not correspond to any features supported by the vehicle 100).

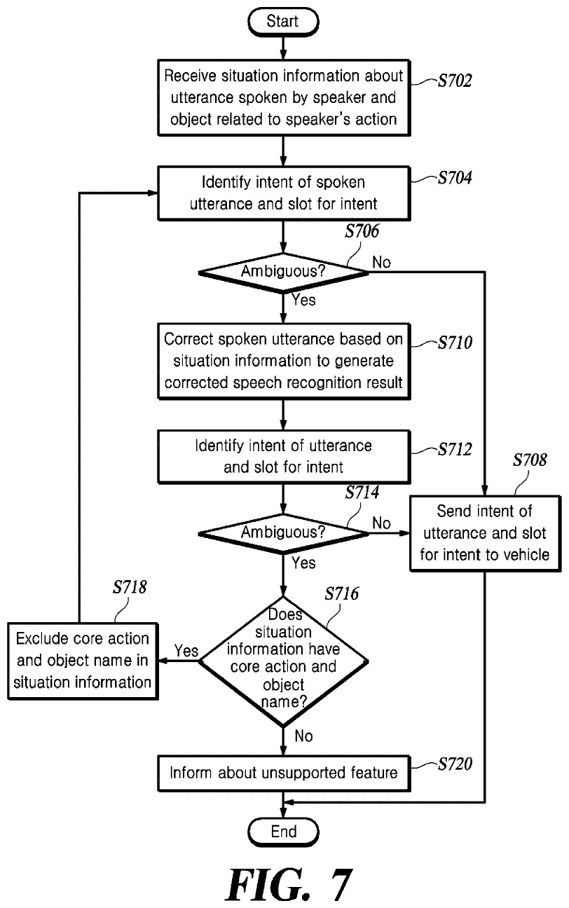

FIG. 7 is a flowchart illustrating a method of correcting a speech recognition result.

The server 120 receives situation information about an utterance spoken by a speaker and an object related to the speaker's action (S702). For example, a spoken utterance “Turn on this”, a core action “hold an item”, and an object name “a can of drink” are received by the server 120. The speech recognition engine 122 converts a spoken utterance from audio to text.

The natural language processing engine 124 identifies the intent of the speaker's utterance and a slot for the intent based on the spoken utterance (S704). For example, the natural language processing engine 124 identifies the intent of the utterance “Turn on this” and a slot for the intent.

The ambiguity determination unit 126 determines the ambiguity of the spoken utterance based on the intent of the utterance and the types of sentences in the spoken utterance (S706). For example, if the utterance contains a demonstrative pronoun or contains only a predicate or an adverb, the ambiguity determination unit 126 determines the utterance to be ambiguous.

If the ambiguity determination unit 126 determines that the spoken utterance is not ambiguous, it sends the intent of the utterance and the slot for the intent to the vehicle 100 (S708).

If the ambiguity determination unit 126 determines that the spoken utterance is ambiguous, it corrects the spoken utterance based on the situation information of the vehicle 100 to generate a corrected speech recognition result (S710). For example, the ambiguity determination unit 126 determines that a sentence “Turn on this” containing a demonstrative pronoun is ambiguous. If situation information extracted from the vehicle situation information determination unit 110 represents “hold a can of drink”, a core action corresponds to “hold an item” and an object name corresponds to “a can of drink”. The speech recognition result creation unit 128 corrects the speech recognition result to change from “Turn on this” to “Turn on a can of drink”.

The natural language processing engine 124 identifies the intent of the utterance and the slot for the intent according to the corrected speech recognition result (S712). For example, the natural language processing engine 124 identifies the intent of the utterance and the slot for the intent according to the corrected speech recognition result “Turn on a can of drink” created by the speech recognition result creation unit 128. Since “a can of drink” is not an object that can be turned on, the speaker's intent is considered out-of-domain (OOD) and the corrected speech recognition result “Turn on a can of drink” is restored back to “Turn on this”.

The ambiguity determination unit 126 determines the ambiguity of the original speech recognition result (S714). For example, the ambiguity determination unit 126 determines the ambiguity of the original speech recognition result “Turn on this”.

If the ambiguity determination unit 126 determines the original speech recognition result to be ambiguous, it determines if the situation information extracted from the vehicle situation information determination unit 110 has a core action and an object name (S716).

If the situation information extracted from the vehicle situation information determination unit 110 has a core action and an object name, it excludes the core action and object name in the situation information (S718). For example, if there is second situation information about a second object, that is extracted from the vehicle situation information determination unit 110, and that represents “touch an item” and “the air conditioner”, the existing situation information representing “hold an item” and “a can of drink” is excluded. The speech recognition result is corrected based on the second situation information representing “hold an item” and “the air conditioner”. The speech recognition result is corrected to change from “Turn on this” to “Turn on the air conditioner”. It is determined whether the corrected second speech recognition result is ambiguous, and a feedback process is performed until the speaker's intent and the speech recognition result match.

If the intent of the utterance is out-of-domain (OOD) with respect to all speech recognition results for the multiple actions, the ambiguity determination unit 126 informs the vehicle 100 that the intent of the utterance corresponds to an unsupported feature (S720). For example, if it is determined through repeated feedback processes that the intent of the utterance is out-of-domain (OOD) with respect to all speech recognition results for the multiple actions, the ambiguity determination unit 126 informs the speech recognition application 102 of the vehicle 100 that the intent of the utterance corresponds to an unsupported feature.

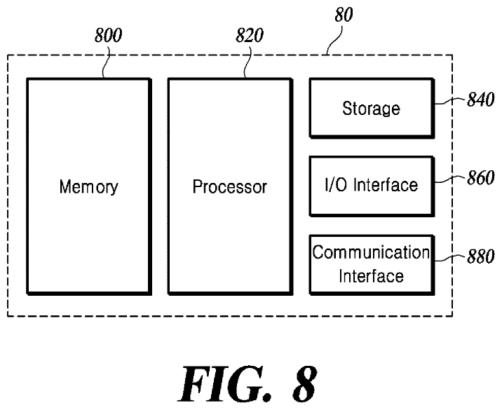

FIG. 8 is a block diagram schematically showing an exemplary computing device that can be used to implement the method or apparatus according to the present disclosure.

The computing device 80 may include some or all of a memory 800, a processor 820, a storage 840, an input/output interface 860, and a communication interface 880. The computing device 80 may structurally and/or functionally include at least a portion of the speech recognition application 102, the camera application 104, the image obtaining unit 106, the conversion engine 108, the vehicle situation information determination unit 110, the speech recognition engine 122, the natural language processing engine 124, the ambiguity determination unit 126 or the speech recognition result creation unit 128. The computing device 80 may be a stationary computing device such as a desktop computer, a server, and an AI accelerator, and may be f mobile computing device such as a laptop computer and a smartphone.

The memory 800 may store a program that causes the processor 820 to perform method or operations. For example, the program may include a plurality of instructions executable by the processor 820, and the method shown in FIG. 7 may be performed by the processor 820 executing the plurality of instructions.

The memory 800 may be a single memory or a plurality of memories. In this case, information required to perform methods or operations may be stored in a single memory or stored in a plurality of memories in a distributed manner. When the memory 800 is configured as a plurality of memories, the plurality of memories may be physically separated.

The memory 800 may include at least one of a volatile memory and a non-volatile memory. The volatile memory includes a static random-access memory (SRAM) or a dynamic random access memory (DRAM), and the non-volatile memory includes a flash memory.

The processor 820 may include at least one core capable of executing at least one instruction. The processor 820 may execute instructions stored in the memory 800. The processor 820 may be a single processor or a plurality of processors.

The storage 840 maintains stored data even if power supplied to the computing device 80 is cut off. For example, the storage 840 may include a non-volatile memory or may include storage media such as a magnetic tape, an optical disk, and a magnetic disk.

The program stored in the storage 840 may be loaded into the memory 800 before being executed by the processor 820. The storage 840 may store files written in a program language, and a program created from a file by a compiler or the like may be loaded into the memory 800. The storage 840 may store data to be processed by processor 820 and/or data processed by processor 820.

The input/output interface 860 may include an input device such as a keyboard and a mouse, and may include an output device such as a display device and a printer. A user may trigger execution of a program by the processor 820 and/or check processing results of the processor 820 through the input/output interface.

The communication interface 880 may provide access to external networks. For example, the computing device 80 may communicate with other devices through the communication interface 880.

Each element of the apparatus or method in accordance with the present disclosure may be implemented in hardware or software, or a combination of hardware and software. The functions of the respective elements may be implemented in software, and a microprocessor may be implemented to execute the software functions corresponding to the respective elements.

One or more example embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various example embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random-access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

A method for a speech recognition apparatus may include: at least one memory; and at least one processor, wherein, by executing commands, the at least one processor is configured to: when a microphone in a vehicle receives an utterance spoken by a speaker, receive situation information about the spoken utterance and an object related to the speaker's action; identify the intent of the speaker's utterance based on the spoken utterance; determine the ambiguity of the spoken utterance based on the intent of the utterance and the types of sentences in the spoken utterance; if the spoken utterance is ambiguous, correct the spoken utterance based on the situation information to generate a corrected speech recognition result.

A speech recognition method may include: when a microphone in a vehicle receives an utterance spoken by a speaker, receiving situation information about the spoken utterance and an object related to the speaker's action; identifying the intent of the speaker's utterance based on the spoken utterance; determining the ambiguity of the spoken utterance based on the intent of the utterance and the types of sentences in the spoken utterance; if the spoken utterance is determined to be ambiguous, correcting the spoken utterance based on the situation information to generate a corrected speech recognition result.

It may possible to correct an ambiguous speech recognition result by obtaining real-time image information from a vehicle interior camera when speech recognition is implemented.

A speech recognition apparatus may be able to understand an utterance containing a demonstrative pronoun and determine a speech recognition result, even when it is not clear what the demonstrative pronoun is referring to.

A speech recognition apparatus may be able to understand a sentence uttered by a speaker that contains only a predicate and determine a speech recognition result.

A speech recognition apparatus may be able to understand a sentence uttered by a speaker that contains only an adverb and determine a speech recognition result, when it is uncertain what action should be taken.

Although operations are illustrated in the flowcharts/timing charts in this specification as being sequentially performed, this is merely an exemplary description of the technical idea of the present disclosure. In other words, those skilled in the art to which the present disclosure belongs may appreciate that various modifications and changes can be made without departing from essential features of example embodiments of the present disclosure, that is, the sequence illustrated in the flowcharts/timing charts can be changed and one or more operations of the operations can be performed in parallel. Thus, flowcharts/timing charts are not limited to the temporal order.

Although example embodiments of the present disclosure have been described for illustrative purposes, those skilled in the art will appreciate that various modifications, additions, and substitutions are possible, without departing from the idea and scope of the claimed disclosure. Therefore, example embodiments of the present disclosure have been described for the sake of brevity and clarity. The scope of the technical idea of the present disclosure is not limited by the illustrations. Accordingly, one of ordinary skill would understand that the scope of the claimed disclosure is not to be limited by the above explicitly described example embodiments but by the claims and equivalents thereof.

What is claimed is:

1. A speech recognition apparatus comprising:
memory storing instructions; and
at least one processor,
wherein the at least one processor, by executing the instructions, is configured to:
receive, via a microphone in a vehicle, an utterance spoken by a user of the vehicle;
identify, based on one or more images received from a camera of the vehicle, context information indicating:
an action of the user while speaking the utterance, and
an object associated with the action;
identify, based on performing speech recognition on the utterance, an intent of the utterance;
identify, based on the intent and based on a sentence type associated with the utterance, an ambiguity associated with the utterance;
adjust, based on the ambiguity and the context information, a result of the speech recognition; and
control, based on the adjusted result of the speech recognition, an operation of the vehicle.

2. The speech recognition apparatus of claim 1, wherein the at least one processor is configured to identify the context information by:
identifying the context information further based on a core action priority database and a core action-free database.

3. The speech recognition apparatus of claim 2, wherein the at least one processor is configured to identify the context information by:
identifying, based on the user performing a plurality of actions, the action according to the core action priority database, and wherein the core action priority database indicates a higher priority for a more specific action of the plurality of actions.

4. The speech recognition apparatus of claim 1, wherein the at least one processor is configured to identify the ambiguity by:
identify the ambiguity further based on the intent being out-of-domain and the utterance comprising a demonstrative pronoun.

5. The speech recognition apparatus of claim 1, wherein the at least one processor is configured to identify the ambiguity by:
identify the ambiguity further based on the intent being out-of-domain and the utterance only containing an adverb or a predicate.

6. The speech recognition apparatus of claim 1, wherein the at least one processor is configured to adjust the result of the speech recognition by:
determining whether the user is performing a plurality of actions;
receiving, based on the user performing the plurality of actions, additional context information indicating a second object associated with a second action; and
adjusting the result of the speech recognition based on the additional context information.

7. The speech recognition apparatus of claim 6, wherein the at least one processor is configured to:
output, based on the intent of the utterance being out-of-domain with respect to the result of the speech recognition and the adjusted result of the speech recognition, a notification that the intent of the utterance corresponds to an unsupported feature.

8. A speech recognition method performed by an apparatus of a vehicle, the speech recognition method comprising:
receiving, via a microphone in the vehicle, an utterance spoken by a user of the vehicle;
identifying, based on one or more images received from a camera of the vehicle, context information indicating:
an action of the user while speaking the utterance, and
an object associated with the action;
identifying, based on performing speech recognition on the utterance, an intent of the utterance;
identifying, based on the intent and based on a sentence type associated with the utterance, an ambiguity associated with the utterance;
adjusting, based on the ambiguity and the context information, a result of the speech recognition; and
controlling, based on the adjusted result of the speech recognition, an operation of the vehicle.

9. The speech recognition method of claim 8, wherein the identifying of the context information comprises:
identifying the context information further based on a core action priority database and a core action-free database.

10. The speech recognition method of claim 9, wherein the identifying of the context information comprises:
identifying, based on the user performing a plurality of actions, the action according to the core action priority database, and wherein the core action priority database indicates a higher priority for a more specific action of the plurality of actions.

11. The speech recognition method of claim 8, wherein the identifying of the ambiguity comprises:
identify the ambiguity further based on the intent being out-of-domain and the utterance comprising a demonstrative pronoun.

12. The speech recognition method of claim 8, wherein the identifying of the ambiguity comprises:
identify the ambiguity further based on the intent being out-of-domain and the utterance only containing an adverb or a predicate.

13. The speech recognition method of claim 8, wherein the adjusting of the result of the speech recognition comprises:
determining whether the user is performing a plurality of actions;
receiving, based on the user performing the plurality of actions, additional context information indicating a second object associated with a second action; and
adjusting the result of the speech recognition based on the additional context information.

14. The speech recognition method of claim 13, further comprising:
outputting, based on the intent of the utterance being out-of-domain with respect to the result of the speech recognition and the adjusted result of the speech recognition, a notification that the intent of the utterance corresponds to an unsupported feature.
